(19) United States
(12) Patent Application Publication
(10) Pub. No.: US 2026/0316999 A1
(43) Pub. Date: Oct. 15, 2026

(54) INTERLOCKING STRUCTURE AND BOX BODY

(71) Applicant: Zhejiang Xianfeng Industrial Co., Ltd., Jinhua (CN)

(72) Inventors: Shuangwen LV, Jinhua (CN); Shuangwu LV, Jinhua (CN)

(73) Assignee: Zhejiang Xianfeng Industrial Co., Ltd., Jinhua (CN)

(21) Appl. No.: 19/402,878

(22) Filed: Nov. 26, 2025

(30) Foreign Application Priority Data
Apr. 14, 2025 (CN) 202510464250.9

(51) Int. Cl. B65D 21/02

(52) U.S. Cl. CPC B65D 21/023

(57) ABSTRACT

An interlocking structure includes clamping grooves which are arranged at two sides of a bottom of an upper box body among an upper box body and a lower box body, and clamping blocks at the top of the lower box body which correspond to the clamping grooves. When two adjacent box bodies are stacked together, the clamping blocks are automatically clamped in the clamping grooves. The interlocking structure further includes: an unlocking assembly, which is located at the bottom of the upper box body and is configured to release the limit on the clamping blocks and the clamping grooves at one side of the box body; and a pressing plate, which is located at the top of the lower box body.

### CROSS-REFERENCE TO RELATED APPLICATIONS

The application claims priority to Chinese Patent Application CN202510464250.9, filed on Apr. 14, 2025, which is incorporated herein by reference in its entirety.

### TECHNICAL FIELD

The present disclosure relates to the technical field of combining box bodies, and in particular, to an interlocking structure and a box body.

### BACKGROUND

The statements herein only provide the background related to the present disclosure and do not necessarily constitute the prior art.

At present, a combined tool box, in which a plurality of upper and lower box bodies can be stacked together, has emerged in the market. An upper box body and a lower box body are combined and spliced in a clamping manner of clamping blocks and clamping grooves. The clamping block is located on the lower box body. When two adjacent box bodies are stacked together, the clamping block is automatically clamped in the clamping groove of the upper box body through a torsion spring.

Because at least two side surfaces of the box body are provided with clamping blocks and clamping grooves, and two clamping blocks and two clamping grooves are usually arranged on each side surface, respectively, in order to facilitate a user to release the limit between the upper box body and the lower box body, an unlocking assembly may be arranged at one side of the box body to release the limit on the clamping blocks and the clamping grooves at one side of the box body (after the limit at one side is released, the limit at the other side does not need to be released deliberately, and the upper box body can be lifted directly to separate the two box bodies).

However, the unlocking assembly often gets stuck due to many reasons, such as lack of lubrication, corrosion, and impurity blockage, so that it is difficult to release the limit between the upper box body and the lower box body, and the normal use of the combined tool box is affected.

### SUMMARY

In order to solve the disadvantages mentioned in the above background, the present disclosure provides an interlocking structure and a box body.

In order to achieve the above objective, the technical solution of the present disclosure is achieved as follows: an interlocking structure, including clamping grooves which are arranged at two sides of a bottom of an upper box body among an upper box body and a lower box body, and clamping blocks which are movably arranged at a top of the lower box body and which correspond to the clamping grooves, where when two adjacent box bodies are stacked together, one end of the clamping block moves from outside to inside and is automatically clamped in the clamping groove, and the interlocking structure further includes:
an unlocking assembly, which is located at the bottom of the upper box body and is configured to release the limit on the clamping blocks and the clamping grooves at one side of the box body; and
a pressing plate, which is located at the top of the lower box body, where one end of the pressing plate is connected with each of the clamping blocks at one side of the box body, and the pressing plate moves outward to drive corresponding clamping blocks to move in a direction away from the clamping grooves.

Further, the number of the pressing plates is equal to the number of the clamping blocks at one side of the box body, and the pressing plates are connected with the clamping blocks at one side of the box body in one-to-one correspondence.

Further, two clamping blocks and two pressing plates are arranged, respectively, and a distance between the two pressing plates is greater than a standard length of a palm.

Further, the unlocking assembly is located at a front side of the box body, and the pressing plate is located at a rear side of the box body.

Further, the unlocking assembly includes an installation groove, the installation groove is located at one side of the box body and communicates with each clamping groove at one side of the box body, a pushing block is slidably arranged at a position where the installation groove communicates with each clamping groove, one side of the pushing block extends into the installation groove, a movable rod is arranged in the installation groove, a wedge-shaped block is arranged at a position of the movable rod corresponding to the pushing block, and the movable rod moves to drive the wedge-shaped block to abut against an inclined surface on the pushing block, so that the pushing block moves into the clamping groove, until the clamping block located in the clamping groove is pushed out of the clamping groove; and the interlocking structure further includes a locking assembly which is configured to lock the position of the movable rod after the clamping block exits from the clamping groove.

Further, the locking assembly includes a limit block vertically slidably arranged on the movable rod, the limit block moves together with the movable rod, a position of a bottom of the box body corresponding to the limit block is provided with a clearance groove, the clearance groove communicates with the installation groove, a first elastic member is arranged between the limit block and the movable rod; and the first elastic member is configured to push one end of the limit block to move downward when the movable rod moves to drive the wedge-shaped block to abut against the inclined surface on the pushing block and pushes the clamping block in the clamping groove out of the clamping groove, so that one end of the limit block passes through the clearance groove downward and contacts with the lower box body; the locking assembly further includes a limit barrier strip arranged at the top of the lower box body, and the limit barrier strip is configured to prevent the limit block from moving together with the movable rod that moves for reset; and the locking assembly further includes a reset block arranged in the installation groove, and the reset block is configured to push the limit block to move upward for reset when the upper box body and the lower box body are separated and the movable rod moves for reset.

Further, the movable rod is a rod body with a non-circular end section, one end of the movable rod extends out of one side of the box body and is provided with a pushing part, the pushing part is operated to push the movable rod to move in the installation groove, one side of the movable rod corresponding to the pushing block is provided with a movable groove, the wedge-shaped block is detachably installed in the movable groove, one side of the pushing block extends into the movable groove and is in sliding fit with an upper side and a lower side of a notch of the movable groove, and the pushing block is capable of moving along a moving direction of the movable rod with respect to the movable groove.

Further, after the movable rod is reset, a side wall of the movable groove contacts with one side of the pushing block.

Further, the pushing part is a pulling wrench, a top of the pulling wrench is located at the side of the box body for fingers to pull the pulling wrench outward, the middle of the pulling wrench is rotatably arranged in the installation groove, and a bottom of the pulling wrench is in sliding contact with the end of the movable rod to push the movable rod to move to one side.

Further, the pushing part further includes an L-shaped fixing block, the fixing block is located at one end of the movable rod corresponding to the pulling wrench, an L-shaped short side of the fixing block is fixedly connected with the movable rod, the bottom of the pulling wrench is provided with a chute, an L-shaped long side of the fixing block passes through the chute, when the pulling wrench moves back and forth, the L-shaped long side of the fixing block is not disengaged from the chute, and the pulling wrench is kept in an open state without being reset after the pulling wrench is pulled to the outside and before the upper box body is lifted, so as to provide a user with information on the unlocking state.

Further, the unlocking assembly further includes a housing part detachably installed at the bottom of the box body, the installation groove is arranged in the housing part, and the pushing block is slidably arranged in the housing part, so that the unlocking assembly integrally forms an independently detachable combined component.

A box body is provided, where the interlocking structure described above is arranged on the box body.

Further, a top of the box body is provided with a convex surface, and a side surface of the convex surface is also used as a limit barrier strip.

The present disclosure has the following beneficial effects.

According to the interlocking structure, when the unlocking assembly is stuck, a user may manually press the pressing plate, so that the pressing plate drives the corresponding clamping blocks to move in a direction away from the clamping grooves. In this way, the limit on the clamping blocks and the clamping grooves at one side of the box body can be released, and then the upper box body can be directly lifted by another user, so that the upper box body and the lower box body are separated to ensure the normal use of a combined tool box.

### BRIEF DESCRIPTION OF THE DRAWINGS

FIG. 1 is a schematic diagram of installing the interlocking structure according to the present disclosure.

FIG. 2 is an enlarged view of A in FIG. 1.

FIG. 3 is a perspective view of the unlocking assembly according to the present disclosure.

FIG. 4 is a schematic diagram of the position of the pushing block according to the present disclosure.

FIG. 5 is a schematic diagram of the structure of the movable rod according to the present disclosure.

FIG. 6 is a schematic diagram of the position of the installation groove according to the present disclosure.

FIG. 7 is a schematic diagram of the structure of the locking assembly according to the present disclosure.

### DETAILED DESCRIPTION OF THE EMBODIMENTS

The present disclosure will be further described in detail with reference to the drawings and embodiments. Obviously, the described embodiments are only some embodiments of the present disclosure, rather than all of the embodiments. The embodiments in the present disclosure and the features in the embodiments can be combined with each other without conflict. Based on the embodiments in the present disclosure, all other embodiments obtained by those skilled in the art without paying creative labor belong to the scope of protection of the present disclosure.

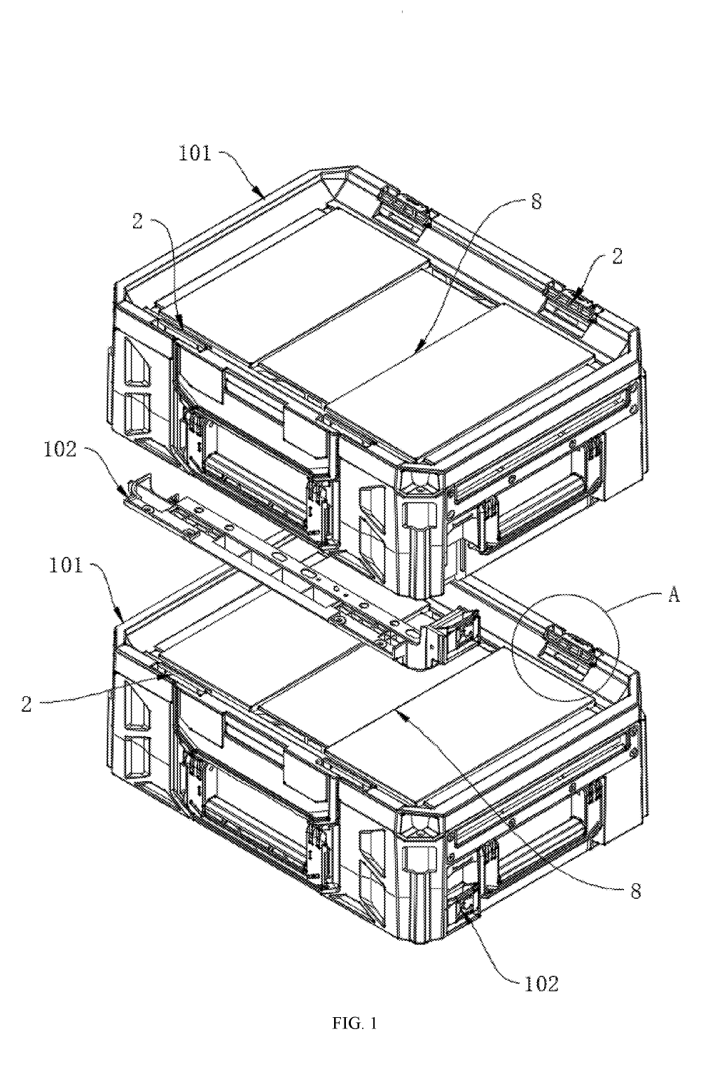

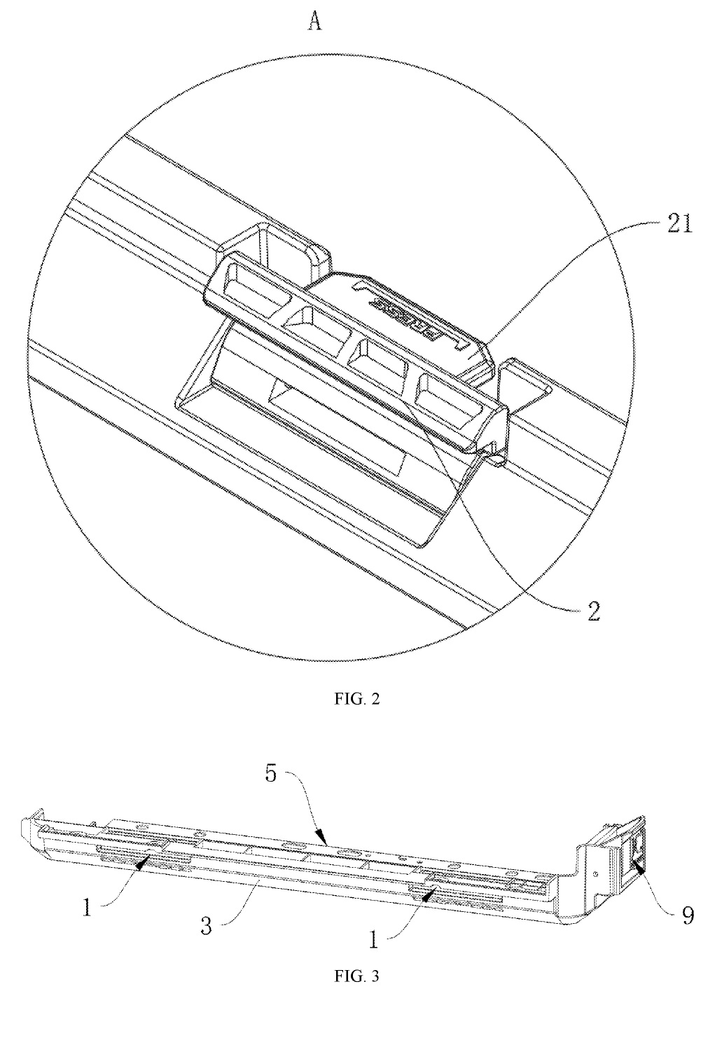

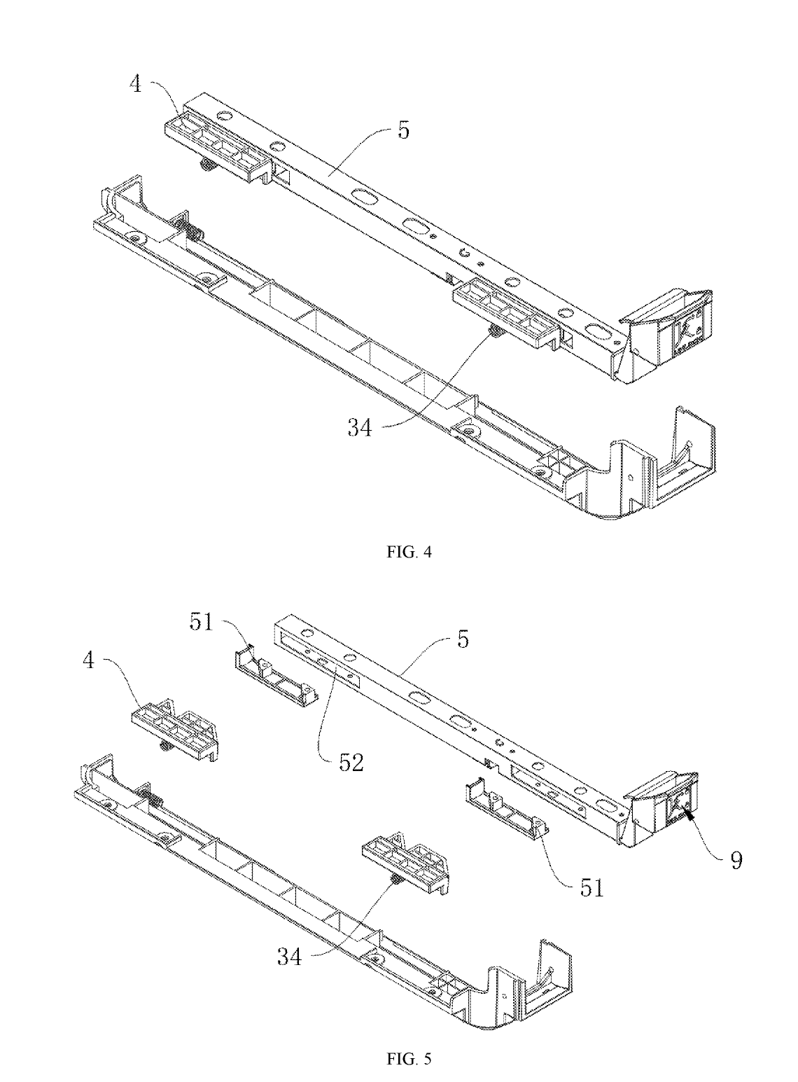

Referring to FIGS. 1-7, the present disclosure provides an interlocking structure. The interlocking structure includes clamping grooves 1 which are arranged at two sides of a bottom of an upper box body 101 among an upper box body and a lower box body 101 (see FIG. 3), and clamping blocks 2 which are movably arranged at a top of the lower box body 101 and which correspond to the clamping grooves 1 (see FIGS. 1 and 2). When two adjacent box bodies 101 are stacked together, one end of the clamping block 2 moves from outside to inside and is automatically clamped in the clamping groove 1. The interlocking structure further includes:
an unlocking assembly 102, which is located at the bottom of the upper box body 101 and is configured to release the limit on the clamping blocks and the clamping grooves 1 at one side of the box body 101; and
a pressing plate 21 (see FIGS. 1 and 2), which is located at the top of the lower box body 101, where one end of the pressing plate 21 is connected with each of the clamping blocks 2 at one side of the box body 101, and the pressing plate 21 moves outward to drive corresponding clamping blocks 2 to move in a direction away from the clamping grooves 1.

In a specific implementation, when the unlocking assembly 102 is stuck, a user may manually press the pressing plate 21, so that the pressing plate 21 drives the corresponding clamping blocks 2 to move in a direction away from the clamping grooves 1. In this way, the limit on the clamping blocks 2 and the clamping grooves 1 at one side of the box body 101 can be released, and then the upper box body 101 can be directly lifted (two people can work together, in which one person presses the pressing plate 21 and the other person moves the box body 101), so that the upper box body and the lower box body 101 are separated to ensure the normal use of a combined tool box.

In an embodiment, the interlocking structure further includes an avoiding groove. The avoiding groove is arranged at the position of the box body 101 corresponding to the pressing plate 21 and is configured to avoid the moving pressing plate 21.

In one embodiment, the number of the pressing plates 21 is equal to the number of the clamping blocks 2 at one side of the box body 101, and the pressing plates are connected with the clamping blocks 2 at one side of the box body 101 in one-to-one correspondence.

Two clamping blocks 2 and two pressing plates 21 are arranged, respectively, and a distance between the two pressing plates 21 is greater than a standard length of a palm.

In a specific implementation, a user can only separately press one of the pressing plates 21 with two hands, so as to release the limit on the clamping block 2 and the clamping groove 1. In this way, the user can exert a more uniform force when pressing with two hands, and the box body 101 may be more stable and less likely to fall or tilt. At the same time, the independent pressing plate 21 can also allow the appearance of the box body 101 to look cleaner and more beautiful, and the cost may also be lower.

Preferably, the palm uses a standard length of a palm of an adult male (refer to ISO 7250 body size standard).

In an embodiment, the unlocking assembly 102 is located at a front side of the box body 101, and the pressing plate 21 is located at a rear side of the box body 101. With this design, the unlocking assembly 102 is located at a front side of the box body 101, which is convenient for a user to unlock for use. However, the pressing plate 21 is not located at the same side of the unlocking assembly 102. This is because on the one hand, there are clamping parts for clamping a box cover at a front side of the box body 101, and the arrangement of the pressing plate 21 may squeeze the arrangement space of the clamping parts, and on the other hand, the pressing plate 21 located at the rear side of the box body 101 may also allow the whole box body to be more harmonious and beautiful. In addition, the unlocking assembly 102 and the pressing plate 21 are not on the same side, which is convenient for two people to work together (one person presses the pressing plate 21 from the back, and the other person moves the box body 101 from the front).

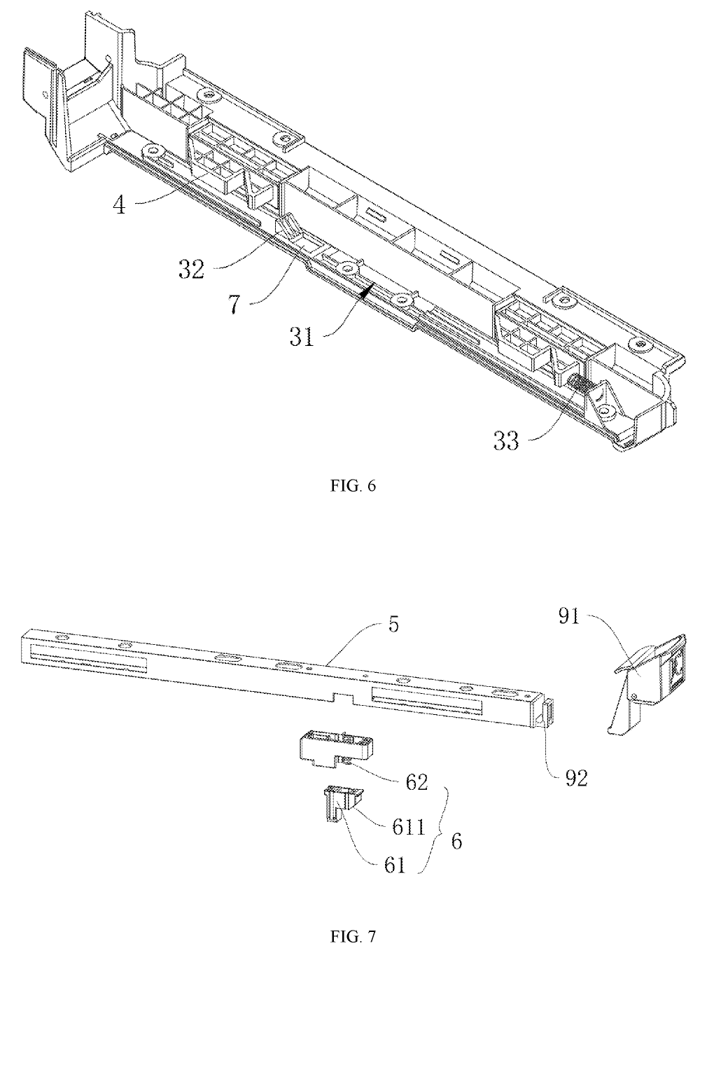

As shown FIG. 6, in an embodiment, the unlocking assembly 102 includes an installation groove 31. The installation groove 31 is located at one side of the box body 101 and communicates with each clamping groove 1 at one side of the box body 101. A pushing block 4 is slidably arranged at a position where the installation groove 31 communicates with each clamping groove 1. One side of the pushing block 4 extends into the installation groove 31. A movable rod 5 is arranged in the installation groove 31. A wedge-shaped block 51 is arranged at a position of the movable rod 5 corresponding to the pushing block 4. The movable rod 5 moves to drive the wedge-shaped block 51 to abut against the inclined surface on the pushing block 4, so that the pushing block 4 moves into the clamping groove 1, until the clamping block 2 located in the clamping groove 1 is pushed out of the clamping groove 1.

The interlocking structure further includes a locking assembly 6 (see FIG. 7) which is configured to lock the position of the movable rod 5 after the clamping block 2 exits from the clamping groove 1.

In a specific implementation, there are many locking assemblies 6 capable of locking the position of the movable rod 5, such as an automatic telescopic locking mechanism installed in a similar automatic cylindrical pen. By arranging the spring in the automatic telescopic locking mechanism at one end of the movable rod 5 in the moving direction and arranging the remaining parts of the automatic telescopic locking mechanism at the other end of the movable rod, the movable rod 5 is manually pushed to move to one side. The position of the movable rod 5 is automatically locked after the movable rod 5 moves into position, and then the movable rod 5 is pushed to move, so that the movable rod 5 can be automatically reset. Of course, the most commonly used top bead limiting structure in the prior art can also be used. A limiting hole is provided in the box body 101. A top bead and the spring are arranged on the movable rod 5. After the movable rod 5 moves into position, the spring pushes a top bead into the limiting hole to limit the movable rod 5. When the movable rod 5 is unlocked, the top bead is pressed to exit from the limiting hole, so as to release the limit on the movable rod 5.

During operation, the interlocking structure manually pushes the movable rod 5, and causes the movable rod 5 to move together with the wedge-shaped block 51 on the movable rod, so that the pushing block 4 moves into the clamping groove 1, until the clamping block 2 located in the clamping groove 1 is pushed out of the clamping groove 1. In this way, unlocking between an upper box body and a lower box body is completed. The arrangement of the locking assembly 6 can prevent the movable rod 5 from displacing, so that the pushing block 4 moves back, thereby preventing the clamping block 2 from re-entering the clamping groove 1. When the unlocking assembly 102 is unlocked normally, the interlocking structure can be operated by a single person, and only one operation is needed to unlock two box bodies, which is convenient to use.

Preferably, the clamping block 2 is rotatably arranged on the lower box body. A torsion spring (not shown in the figure) is arranged between a rotating shaft of the clamping block 2 and the box body. Driven by the torsion spring, the clamping block 2 moves to one side of the clamping groove 1 and is engaged with the clamping groove 1.

In one embodiment, the locking assembly 6 includes a limit block 61 vertically slidably arranged on the movable rod 5. The limit block 61 moves together with the movable rod 5. A position of a bottom of the box body corresponding to the limit block 61 is provided with a clearance groove 7. The clearance groove 7 communicates with the installation groove 31. A first elastic member 62 is arranged between the limit block 61 and the movable rod 5. The first elastic member 62 is configured to push one end of the limit block 61 to move downward when the movable rod 5 moves to drive the wedge-shaped block 51 to abut against the inclined surface on the pushing block 4 and pushes the clamping block 2 in the clamping groove 1 out of the clamping groove 1, so that one end of the limit block 61 passes through the clearance groove 7 downward and contacts with the lower box body.

The locking assembly further includes a limit barrier strip 8 arranged at a top of the lower box body (see FIG. 1), and the limit barrier strip 8 is configured to prevent the limit block 61 from moving together with the movable rod 5 that moves for reset.

The locking assembly further includes a reset block 32 arranged in the installation groove 31, and the reset block 32 is configured to push the limit block 61 to move upward for reset when the upper box body and the lower box body are separated and the movable rod 5 moves for reset.

In a specific implementation, the limit block 61 moves together with the movable rod 5. After the clamping block 2 exits from the clamping groove 1 and the movable rod 5 moves into position, the limit block 61 is released from the constraint of the reset block 32, and extends to the limit barrier strip 8 on the lower box body when being pushed by the first elastic member 62, so as to cooperate with the limit barrier strip 8 and prevent the limit block 61 from moving for reset. After the upper box body and the lower box body are separated, the limiting relationship between the limit block 61 and the limit barrier strip 8 is automatically released. At this time, when the movable rod 5 moves for reset, the limit block 61 may move upward for reset when being pushed by the reset block 32, which is convenient to recombine the upper box body and the lower box body.

Preferably, the limit barrier strip 8 is a groove wall of the groove at the top of the lower box body.

In an embodiment, a second elastic member 33 is arranged in the installation groove 31, and the second elastic member 33 is configured to push the movable rod 5 to reset. With this design, although the movable rod 5 can be reset manually without the second elastic member 33, the convenience of a user can be further improved with the second elastic member 33.

In an embodiment, the reset block 32 (see FIG. 6) is an inclined-surface block arranged in the installation groove 31, and the inclined-surface block is located at the clearance groove 7; one side of the limit block 61 corresponding to the inclined-surface block is provided with a contact part 611, and the contact part 611 is in sliding contact with the inclined surface on the inclined-surface block, and is configured to abut against the inclined surface on the inclined-surface block when the movable rod 5 is reset to force the limit block 61 to move upward.

In an embodiment, the interlocking structure further includes a third elastic member 34 (see FIG. 5), and the third elastic member 34 is configured to push the pushing block 4 to move to the side away from the clamping groove 1. This design can avoid the fact that when the upper box body and the lower box body are stacked together again, the clamping block 2 cannot be engaged with the clamping groove 1 when being blocked by the pushing block 4 (because the clamping block 2 moves in an arc shape, and the pushing block 4 moves in a straight line, the pushing block 4 pushes the clamping block 2 out of the clamping groove 1 easily, but the clamping block 2 cannot easily move the pushing block 4 in turn).

Preferably, the third elastic member 34 can be arranged between the pushing block 4 and the box body, between the pushing block 4 and the installation groove 31, between the housing part 3 mentioned later and the pushing block 4, or the like. The specific position is not limited too much.

Preferably, the first elastic member 62, the second elastic member 33, and the third elastic member 34 can all be springs.

As shown in FIG. 5, in one embodiment, the movable rod 5 is a rod body with a non-circular end section. One end of the movable rod 5 extends out of one side of the box body and is provided with a pushing part 9. The pushing part 9 is operated to push the movable rod 5 to move in the installation groove 31. One side of the movable rod 5 corresponding to the pushing block 4 is provided with a movable groove 52. The wedge-shaped block 51 is detachably installed in the movable groove 52. One side of the pushing block 4 extends into the movable groove 52 and is in sliding fit with an upper side and a lower side of a notch of the movable groove 52, and the pushing block 4 is capable of moving along a moving direction of the movable rod 5 with respect to the movable groove 52.

In a specific implementation, the detachable design of the wedge-shaped block 51 enables the wedge-shaped block 51 to be replaced when the wedge-shaped block 51 is seriously worn. By allowing one side of the pushing block 4 to extend into the movable groove 52, on the one hand, it is convenient to assemble and position, and on the other hand, the pushing block 4 can be prevented from inclining upward or downward under the action of an external force. At the same time, the appearance of the movable rod 5 is more concise. All parts are located in the rod, which is convenient to sell the movable rod 5 as a single part.

Preferably, the pushing part 9 is a block fixed at the end of the movable rod 5 for fingers to press.

In one embodiment, after the movable rod 5 is reset, a side wall of the movable groove 52 contacts with one side of the pushing block 4. This design can prevent the movable rod 5 from moving too much when the movable rod 5 is reset. Moreover, with this structure, there is no need to arrange another structure for limiting the displacement distance of the movable rod 5, thereby reducing the structural complexity, and reducing the production and manufacturing costs to a certain extent.

As shown in FIG. 7, in one embodiment, in order to facilitate a user to push the movable rod 5, the pushing part 9 is a pulling wrench 91. A top of the pulling wrench 91 is located at the side of the box body for fingers to pull the pulling wrench outward. The middle of the pulling wrench 91 is rotatably arranged in the installation groove 31, and a bottom of the pulling wrench 91 is in sliding contact with the end of the movable rod 5 to push the movable rod 5 to move to one side. This design reduces the difficulty of pushing the movable rod 5, which is convenient for a user to operate.

In one embodiment, the pushing part 9 further includes an L-shaped fixing block 92. The fixing block 92 is located at one end of the movable rod 5 corresponding to the pulling wrench 91. An L-shaped short side of the fixing block 92 is fixedly connected with the movable rod 5. The bottom of the pulling wrench 91 is provided with a chute. An L-shaped long side of the fixing block 92 passes through the chute. When the pulling wrench 91 moves back and forth, the L-shaped long side of the fixing block 92 is not disengaged from the chute. With this design, when the movable rod 5 is reset, the L-shaped fixing block 92 can drive the pulling wrench 91 to reset without arranging a reset torsion spring on the pulling wrench 91. Moreover, the pulling wrench 91 is kept in an open state without being reset after the pulling wrench 91 is pulled to the outside and before the upper box body is separated from the lower box body, so as to provide a user with information on the unlocking state. The user can perceive whether the upper box body and the lower box body are in the locking state at present by observing the posture of the pulling wrench 91.

In an embodiment, the unlocking assembly 102 further includes a housing part 3 detachably installed at the bottom of the box body (see FIG. 3). The installation groove 31 and the third elastic member 34 are arranged in the housing part 3, and the pushing block 4 is slidably arranged in the housing part 3, so that the unlocking assembly 102 integrally forms an independently detachable combined component. With this design, the whole unlocking assembly 102 can be sold as an independent part, and the original unlocking assembly 102 can be directly removed and replaced with a new unlocking assembly 102 during maintenance and replacement.

Preferably, an assembly groove is arranged at the position of the box body corresponding to the housing part 3, which is configured to install the housing part 3.

In one embodiment, the clamping groove 1 at one side of the bottom of the box body corresponding to the housing part 3 is arranged on the housing part 3. With this design, the overall accuracy may be higher, and misalignment does not occur easily between the pushing block 4 and the clamping groove 1.

The present disclosure further provides a box body, where the interlocking structure described above is arranged on the box body.

In one embodiment, the top of the lower box body is provided with a convex surface, and the side surface of the convex surface is also used as the limit barrier strip 8. With this design, a shape of a surface of the box cover at a top of the box body is used. The convex surface (that is, a large convex surface) is a main load-bearing surface, and in addition, the edge plays the role of limiting.

The above is only the preferred embodiment of the present disclosure, and is not used to limit the present disclosure. Any modification, equivalent replacement, improvement, and the like made within the spirit and principle of the present disclosure should be included in the scope of protection of the present disclosure.

It should be noted that if there are directional indications (such as up and down) in the embodiment of the present disclosure, the directional indications are only used to explain the relative position relationship and movement situation between components in a specific posture (as shown in the drawing). If the specific posture changes, the directional indications may also change accordingly.

In addition, the meaning of "and/or" appearing in the present disclosure includes three parallel solutions, taking "A and/or B" as an example, including solution A, solution B, or a solution that A and B satisfy simultaneously. In addition, if there are descriptions related to "first" and "second" in the embodiment of the present disclosure, the descriptions of "first" and "second" are only used for descriptive purposes, and cannot be understood as indicating or implying the relative importance or implicitly indicating the number of indicated technical features. Therefore, the features defined as "first" and "second" can explicitly or implicitly include at least one of the features. In addition, "a plurality of" refers to more than two. In addition, the technical solutions of various embodiments can be combined with each other, but the technical solutions must be based on the feasibility for those skilled in the art to implement. When the combination of technical solutions is contradictory or impossible, it should be considered that the combination of technical solutions does not exist and is not within the scope of protection of the present disclosure.

What is claimed is:

1. An interlocking structure, comprising clamping grooves which are arranged at two sides of a bottom of an upper box body among an upper box body and a lower box body, and clamping blocks which are movably arranged at a top of the lower box body and which correspond to the clamping grooves, wherein when two adjacent box bodies are stacked together, one end of the clamping block moves from outside to inside and is automatically clamped in the clamping groove, and the interlocking structure further comprises:
an unlocking assembly, which is located at the bottom of the upper box body and is configured to release the limit on the clamping blocks and the clamping grooves at one side of the box body; and
a pressing plate, which is located at the top of the lower box body, wherein one end of the pressing plate is connected with each of the clamping blocks at one side of the box body, and the pressing plate moves outward to drive corresponding clamping blocks to move in a direction away from the clamping grooves.

2. The interlocking structure according to claim 1, wherein the number of the pressing plates is equal to the number of the clamping blocks at one side of the box body, and the pressing plates are connected with the clamping blocks at one side of the box body in one-to-one correspondence.

3. The interlocking structure according to claim 2, wherein two clamping blocks and two pressing plates are arranged, respectively, and a distance between the two pressing plates is greater than a standard length of a palm.

4. The interlocking structure according to claim 1, wherein the unlocking assembly is located at a front side of the box body, and the pressing plate is located at a rear side of the box body.

5. The interlocking structure according to claim 1, wherein the unlocking assembly comprises an installation groove, the installation groove is located at one side of the box body and communicates with each clamping groove at one side of the box body, a pushing block is slidably arranged at a position where the installation groove communicates with each clamping groove, one side of the pushing block extends into the installation groove, a movable rod is arranged in the installation groove, a wedge-shaped block is arranged at a position of the movable rod corresponding to the pushing block, and the movable rod moves to drive the wedge-shaped block to abut against an inclined surface on the pushing block, so that the pushing block moves into the clamping groove, until the clamping block located in the clamping groove is pushed out of the clamping groove; and
the interlocking structure further comprises a locking assembly which is configured to lock the position of the movable rod after the clamping block exits from the clamping groove.

6. The interlocking structure according to claim 5, wherein the locking assembly comprises a limit block vertically slidably arranged on the movable rod, the limit block moves together with the movable rod, a position of a bottom of the box body corresponding to the limit block is provided with a clearance groove, the clearance groove communicates with the installation groove, a first elastic member is arranged between the limit block and the movable rod; and the first elastic member is configured to push one end of the limit block to move downward when the movable rod moves to drive the wedge-shaped block to abut against the inclined surface on the pushing block and pushes the clamping block in the clamping groove out of the clamping groove, so that one end of the limit block passes through the clearance groove downward and contacts with the lower box body;
the locking assembly further comprises a limit barrier strip arranged at the top of the lower box body, and the limit barrier strip is configured to prevent the limit block from moving together with the movable rod that moves for reset; and
the locking assembly further comprises a reset block arranged in the installation groove, and the reset block is configured to push the limit block to move upward for reset when the upper box body and the lower box body are separated and the movable rod moves for reset.

7. The interlocking structure according to claim 5, wherein the movable rod is a rod body with a non-circular end section, one end of the movable rod extends out of one side of the box body and is provided with a pushing part, the pushing part is operated to push the movable rod to move in the installation groove, one side of the movable rod corresponding to the pushing block is provided with a movable groove, the wedge-shaped block is detachably installed in the movable groove, one side of the pushing block extends into the movable groove and is in sliding fit with an upper side and a lower side of a notch of the movable groove, and the pushing block is capable of moving along a moving direction of the movable rod with respect to the movable groove.

8. The interlocking structure according to claim 7, wherein after the movable rod is reset, a side wall of the movable groove contacts with one side of the pushing block.

9. The interlocking structure according to claim 7, wherein the pushing part is a pulling wrench, a top of the pulling wrench is located at the side of the box body for fingers to pull the pulling wrench outward, the middle of the pulling wrench is rotatably arranged in the installation groove, and a bottom of the pulling wrench is in sliding contact with the end of the movable rod to push the movable rod to move to one side.

10. The interlocking structure according to claim 9, wherein the pushing part further comprises an L-shaped fixing block, the fixing block is located at one end of the movable rod corresponding to the pulling wrench, an L-shaped short side of the fixing block is fixedly connected with the movable rod, the bottom of the pulling wrench is provided with a chute, an L-shaped long side of the fixing block passes through the chute, when the pulling wrench moves back and forth, the L-shaped long side of the fixing block is not disengaged from the chute, and the pulling wrench is kept in an open state without being reset after the pulling wrench is pulled to the outside and before the upper box body is lifted, so as to provide a user with information on the unlocking state.

11. The interlocking structure according to claim 5, wherein the unlocking assembly further comprises a housing part detachably installed at the bottom of the box body, the installation groove is arranged in the housing part, and the pushing block is slidably arranged in the housing part, so that the unlocking assembly integrally forms an independently detachable combined component.

12. A box body, wherein the interlocking structure according to claim 1 is arranged on the box body.

13. The box body according to claim 12, wherein a top of the box body is provided with a convex surface, and a side surface of the convex surface is also used as a limit barrier strip.
